(19) United States
(12) Patent Application Publication
(10) Pub. No.: US 2021/0109475 A1
(43) Pub. Date: Apr. 15, 2021

(54) IMAGE FORMING APPARATUS

(71) Applicant: Oki Data Corporation, Tokyo (JP)

(72) Inventor: Yasumasa SAGAWA, Tokyo (JP)

(21) Appl. No.: 17/067,658

(22) Filed: Oct. 10, 2020

(30) Foreign Application Priority Data
Oct. 15, 2019 (JP) 2019-188404

(51) Int. Cl. G03G 21/16; G03G 15/20

(52) U.S. Cl. CPC G03G 21/1633; G03G 15/201; G03G 21/1685

(57) ABSTRACT

An image forming apparatus includes an apparatus main body; a cover member that is provided rotatable in a rotation direction about a rotation axis with respect to the apparatus main body, having an opening part, a fuser that fuses a toner image formed on each medium of media wherein the fuser is attached to the apparatus main body by being inserted through the opening part and detached from the apparatus main body by being pulled out of the opening part; and a sub cover member that has an surface portion and is attached to the fuser, wherein in a state in which the fuser is attached to the image forming apparatus, the surface portion of the sub cover is arranged within the opening part, the sub cover member moves in the rotation direction in correspondence with the rotation of the cover member.

### TECHNICAL FIELD

The present invention relates to an image forming apparatus and can be suitably applied to, for example, an electrophotographic image forming apparatus.

### BACKGROUND

In an image forming apparatus such as a copying machine, a printer, or a facsimile that forms an image using an electrophotographic method, an image transferred to a medium using a developer is fused on a medium by a fuser (for example, see Patent Document 1). Conventionally, an electrophotographic image forming apparatus has a structure in which a fuser is accommodated inside an apparatus casing. When the fuser is taken out from the apparatus casing due to sheet jamming or the like, a top cover provided on the apparatus casing is opened to expose the fuser to the outside, and then, the fuser is taken out.

### RELATED ART

### Patent Document(s)

[Patent Doc. 1] JP Laid-Open Patent Application Publication 2008-33295

### Subjects to be Solved

As described above, in the conventional image forming apparatus, since the fuser cannot be taken out from the apparatus casing without opening the top cover, there is a problem that workability in taking out the fuser is poor. In order to take out the fuser directly from the apparatus casing via an opening part without opening the top cover, a structure for preventing formation of a gap between the fuser and the opening part is required.

The present invention is accomplished in consideration of the above problem, and is intended to propose an image forming apparatus that can improve the workability in taking out a fuser.

### SUMMARY

An image forming apparatus, disclosed in the application, includes an apparatus main body; a cover member that is provided rotatable in a rotation direction about a rotation axis with respect to the apparatus main body, having an opening part, a fuser that fuses a toner image formed on each medium of media wherein the fuser is attached to the apparatus main body by being inserted through the opening part and detached from the apparatus main body by being pulled out of the opening part; and a sub cover member that has an surface portion and is attached to the fuser, wherein in a state in which the fuser is attached to the image forming apparatus, the surface portion of the sub cover is arranged within the opening part, the sub cover member moves in the rotation direction in correspondence with the rotation of the cover member.

In the present invention, the fuser can be directly taken out from the apparatus casing via the opening part of the cover member that rotates/swings the sub cover member.

According to the present invention, the fuser can be directly taken out from the apparatus casing via the opening part of the cover member that rotates/swings the sub cover member, and thus, an image forming apparatus that can improve the workability in taking out the fuser as compared to a conventional technology can be realized.

### BRIEF DESCRIPTION OF THE DRAWINGS

FIG. 1 is a perspective view illustrating an external configuration of an image forming apparatus in a top cover closed state.

FIG. 2 is a perspective view illustrating the external configuration of the image forming apparatus in a top cover opened state.

FIG. 3 is a left side view illustrating an internal configuration of the image forming apparatus.

FIG. 4 is a left side view illustrating configurations of a top cover and a fuser unit in a fuser detached state.

FIG. 5 is a perspective view illustrating the configuration of the top cover in the fuser detached state.

FIG. 6 is a perspective view illustrating the configuration of the top cover in a fuser attached state.

FIG. 7 is a perspective view illustrating the configuration (1) of the fuser unit.

FIG. 8 is a perspective view illustrating the configuration (2) of the fuser unit.

FIG. 9 is a left side view illustrating the configurations of the top cover and the fuser unit in the fuser attached state and the top cover closed state.

FIG. 10 is a left side view illustrating the configurations of the top cover and the fuser unit in the fuser attached state and the top cover opened state.

FIG. 11 is a perspective view illustrating the configuration of the fuser unit in the fuser attached state and a sub cover closed state.

FIG. 12 is a perspective view illustrating the configuration of the fuser unit in the fuser attached state and a sub cover opened state.

FIG. 13 is a left side view illustrating how sheets are stacked in the top cover closed state.

FIG. 14 is a left side view illustrating how sheets are stacked in the top cover opened state.

FIG. 15 is a left side view illustrating flow of cooling air.

FIG. 16 is a perspective view illustrating a fuser unit in which handles are pulled out.

### DETAILED DESCRIPTION OF THE PREFERRED EMBODIMENT(S)

In the following, modes for carrying out the invention (hereinafter referred to as embodiments) are described using the drawings.

### 1. External Configuration of the Image Forming Apparatus

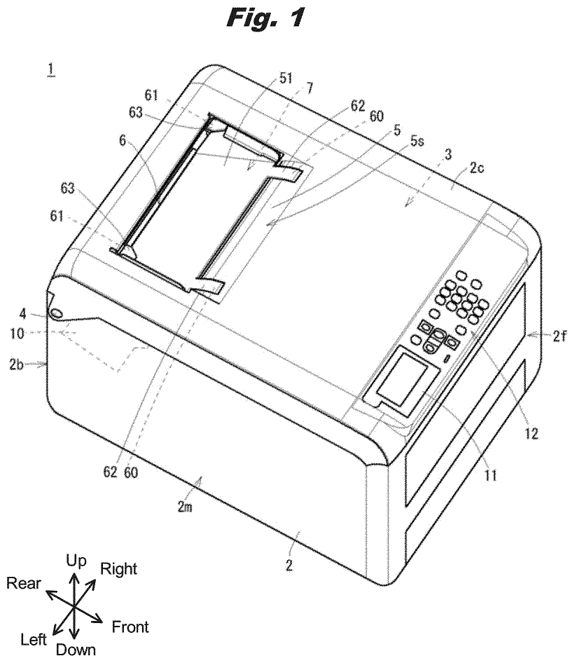

As illustrated in FIGS. 1-3, an image forming apparatus 1 is a printer that forms (that is, prints) an image on a sheet using an electrophotographic method.

First, an external configuration of the image forming apparatus 1 is described. The image forming apparatus 1 has an apparatus casing 2 of a substantially rectangular parallelepiped shape as an external covering. Here, a direction from a front surface 2f to a rear surface 2b of the apparatus casing 2 is defined as a rearward direction; a direction from the rear surface 2b to the front surface 2f is defined as a frontward direction; a direction from a lower side to an upper side of the apparatus casing 2 is defined as an upward direction; a direction from the upper side to the lower side of the apparatus casing 2 is defined as a downward direction; a direction from a right side to a left side of the apparatus casing 2 is defined as a leftward direction; and a direction from the left side to the right side of the apparatus casing 2 is defined as a rightward direction.

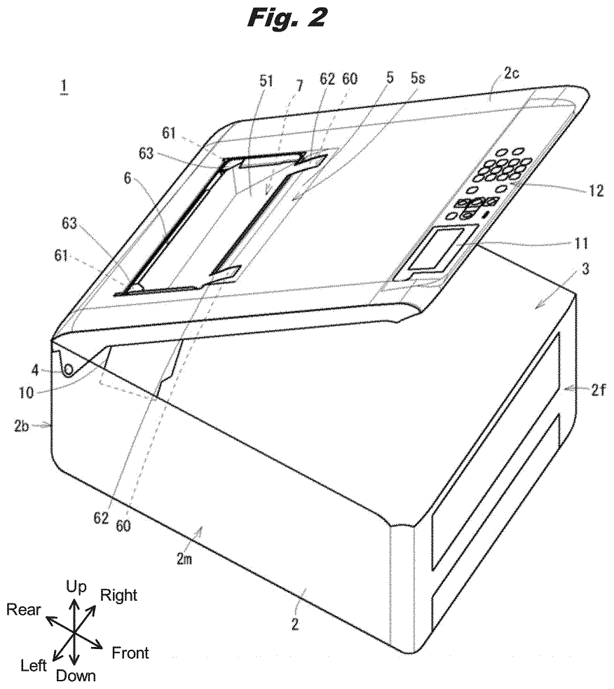

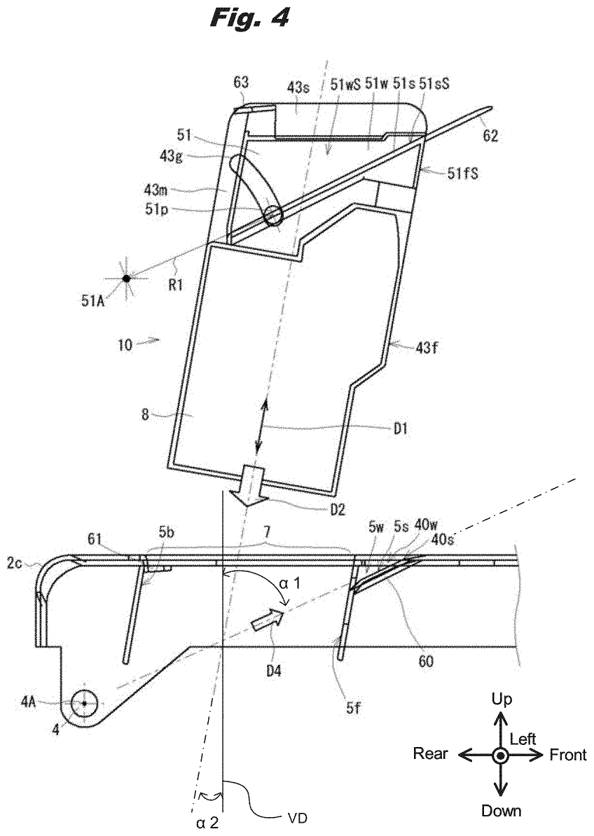

The apparatus casing 2 includes a substantially box-shaped casing main body part 2m of which an upper surface forms a main body side opening part 3, and a lid-like top cover 2c that forms an upper surface of the apparatus casing 2 and covers the main body side opening part 3 of the casing main body part 2m. As illustrated in FIG. 2, a top cover rotation shaft 4 that is provided at a rear end of the top cover 2c and extends in a left-right direction is rotatably supported by a bearing part (not illustrated in the drawings) provided at an upper end of a rear end part of the casing main body part 2m. As a result, as illustrated in FIG. 4, the top cover 2c opens when a front side thereof rotates about a top cover rotation center axis 4A which is a center of the top cover rotation shaft 4 in a top cover opening direction away from the casing main body part 2m, and closes when front side rotates in a top cover closing direction approaching the casing main body part 2m. In this application, the two opposite directions, which are open direction and close direction, are defined as a rotation direction or rotation directions. The rotation of the cover 2c means either that the cover is being lifted to open, or that the cover is being shut down to close. When the top cover 2c is opened, an inside of the image forming apparatus 1 can be accessed by exposing the inside from the main body side opening part 3 of the casing main body part 2m. In the following, as a state of the top cover 2c, a state in which the top cover 2c is closed to cover the main body side opening part 3 is referred to as a top cover closed state (FIG. 1), and a state in which the top cover 2c is opened so that the inside is exposed from the main body side opening part 3 is referred to as a top cover opened state (FIG. 2).

Further, as illustrated in FIGS. 1, 3 and 9, a portion of an upper surface of the top cover 2c is recessed, and this recessed portion forms a sheet stacker part 5 that stacks (accumulates) sheets. That is, the top cover 2c has the sheet stacker part 5 on the upper surface thereof as an outer peripheral part. In the sheet stacker part 5, a stack surface 5s as a bottom surface for stacking sheets is an inclined surface that gently rises from a rear end to a front end thereof. The stack surface 5s has an angle (a 1), which is ranged from 45 to 80 degrees, with respect to the vertical direction (VD). Further, in the sheet stacker part 5, stack part side wall surfaces 5w are respectively formed at left and right two ends of the stack surface 5s. In the image forming apparatus 1, a sheet ejected forward from a sheet ejection port 6, which is provided at a lower end part of a top cover insertion port rear side wall surface 5b (FIG. 4) of the sheet stacker part 5, is stacked on the stack surface 5s of the sheet stacker part 5.

Further, in the top cover 2c, a fuser insertion port 7 is provided at a rear part of the sheet stacker part 5. The fuser insertion port 7 is a hole which is long in the left-right direction, and communicatively connects between an upper side and a lower side of the top cover 2c at the rear part of the sheet stacker part 5.

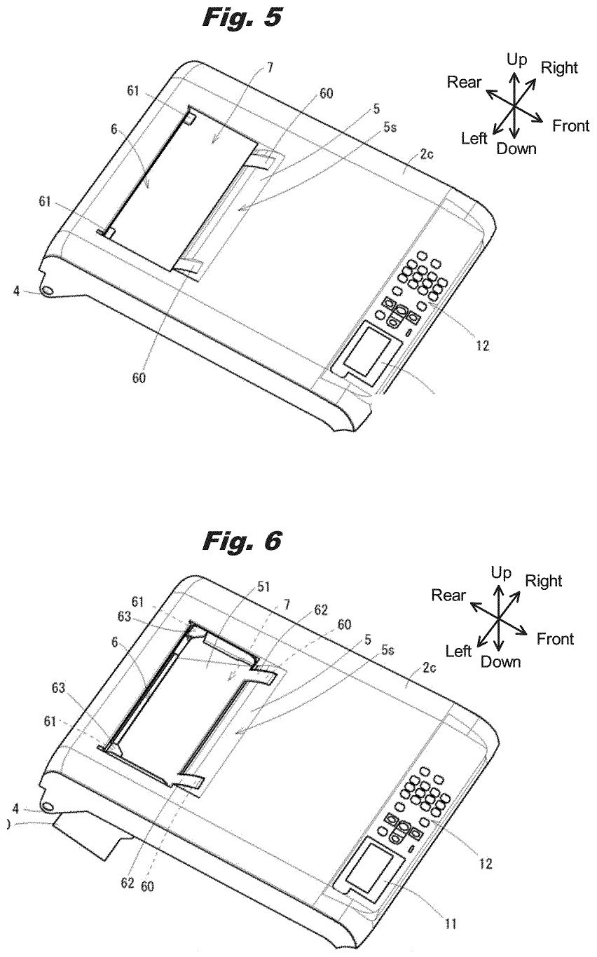

In the image forming apparatus 1, from the fuser insertion port 7, a fuser unit 10 is detachably attached to the casing main body part 2m along a fuser insertion/removal direction D1 (FIG. 4) in which an upper side of the fuser unit 10 is slightly inclined forward with respect to a vertical direction (VD) which is perpendicular to a bottom surface of the apparatus casing 2. The insertion/removal direction D1 has angle α2 ranged from 5 to 50 degrees with respect to the vertical direction VD. In this invention, the vertical direction (VD) may be determined parallel to the gravity, but may be determined perpendicular to the top surface of the apparatus 1. When the fuser unit 10 is attached to the casing main body part 2m, an upper surface of a sub cover 51 of the fuser unit 10 is exposed to the outside. The fuser unit 10 can be attached by moving with respect to the top cover 2c in a downward fuser insertion direction D2 (FIG. 4) which is one direction of the fuser insertion/removal direction D1 along a linear direction. That is, by being attached to the top cover 2c during a print operation, the fuser unit 10 is in a fuser attached state illustrated in FIGS. 1, 3, 6 and 9. On the other hand, when the fuser unit 10 is to be removed from the top cover 2c due to sheet jamming or the like, the fuser unit 10 is removed by being lifted from the fuser attached state in an upward fuser removal direction (not illustrated in the drawings) which is the other direction of the fuser insertion/removal direction D1, and the fuser unit 10 is in a fuser detached state illustrated in FIGS. 4 and 5. The fuser unit 10 will be described in detail later. The upper surface of the fuser unit 10 has a shape that closes the fuser insertion port 7 and forms the rear part of the sheet stacker part 5 (that is, the rear parts of the stack surface 5s and the left and right stack part side wall surfaces 5w of the sheet stacker part 5).

Here, the top cover insertion port rear side wall surface 5b of the sheet stacker part 5 is a part of the top cover 2c, and is a flat surface that extends from a rear end part of the fuser insertion port 7 along the fuser insertion direction D2 and faces forward. Further, a top cover insertion port front side wall surface 5f is a part of the top cover 2c, and is a flat surface that extends from a front end part of the fuser insertion port 7 along the fuser insertion direction D2 and faces rearward so as to oppose the top cover insertion port rear side wall surface 5b. That is, i the sheet stacker part 5, the stack surface 5s and the stack part side wall surfaces 5w are formed by the top cover 2c and the fuser unit 10, and the top cover insertion port rear side wall surface 5b is formed by the top cover 2c. The stack surface 5s extends from the sheet ejection port 6 along a sheet ejection direction D4 (or medium ejection direction) which is a direction in which a sheet is ejected.

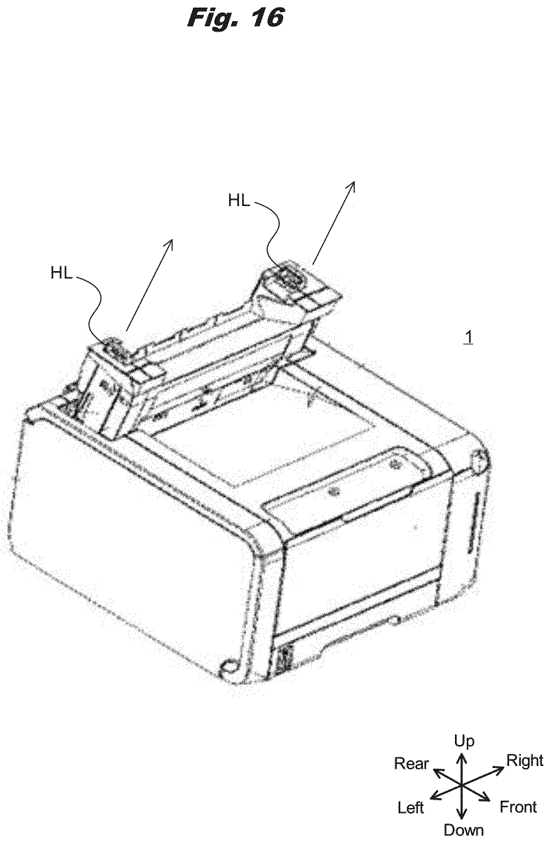

Further, on the upper surface of the fuser unit 10, a pair of handles HL are respectively provided on left and right two outer side portions of the sheet stacker part 5. The handles are shown in FIG. 16. With the top cover 2c of the image forming apparatus 1 in the top cover closed state, by grasping the handles exposed from the fuser insertion port 7 of the top cover 2c and pulling the handles upward (in the fuser removal direction), the fuser unit 10 attached to the casing main body part 2m can be taken out from the casing main body part 2m via the fuser insertion port 7 of the top cover 2c. The pulling direction of handles HL is shown with arrows in FIG. 16.

Further, on a front end of the top cover 2c, a display panel 11, which allows touch operations to be performed and displays various types of information, and operation buttons 12 or the like are provided. Further, although not illustrated in the drawings, a handle or the like that can be used when opening or closing the top cover 2c is provided at a predetermined place on the top cover 2c.

### 2. Internal Configuration of the Image Forming Apparatus

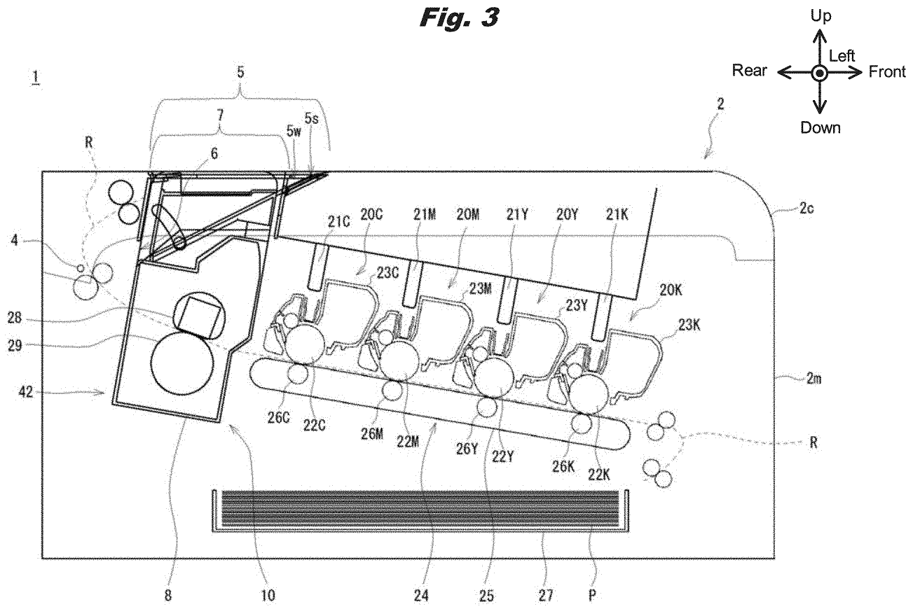

Next, an internal structure of the image forming apparatus 1 is described. As illustrated in FIG. 3, inside the apparatus casing 2, parts are arranged along a carrying path R along which a sheet P is carried. That is, inside the apparatus casing 2, substantially at a center in an up-down direction, four image forming units 20 (image forming units 20K, 20Y, 20M and 20C) respectively corresponding to colors of multiple developers (for example, toners of four colors including black (K), yellow (Y), magenta (M) and cyan (C)) handled in the image forming apparatus 1 are arranged in a front-rear direction along the carrying path R. In the following, the left-right direction which is orthogonal to a carrying direction of the sheet P and to a thickness direction normal to a surface of the sheet P is also referred to as a carrying width direction.

The image forming units 20 (image forming units 20K, 20Y, 20M and 20C) respectively have LED heads 21 (LED heads 21K, 21Y, 21M and 21C), photosensitive drums 22 (photosensitive drums 22K, 22Y, 22M and 22C), and toner containers 23 (toner containers 23K, 23Y, 23M and 23C). The image forming units 20 are each a hardware device in which the LED head 21 emits light to expose a surface of the photosensitive drum 22 to form an electrostatic latent image on the surface of the photosensitive drum 22, and then, a toner supplied from the toner container 23 is attached to the electrostatic latent image to form a toner image on the surface of the photosensitive drum 22.

Further, inside the apparatus casing 2, a transfer unit 24 is provided below the four image forming units 20. The transfer unit 24 includes an annular carrying belt 25 that is provided freely movable in the front-rear direction along the carrying path R, and transfer rollers 26 (transfer rollers 26K, 26Y, 26M and 26C) that are respectively arranged opposing lower sides of the photosensitive drums 22 (photosensitive drums 22K, 22Y, 22M and 22C) with the carrying belt 25 sandwiched therebetween.

The transfer rollers 26 are each a member that, when the sheet P passes between the photosensitive drum 22 and the carrying belt 25, transfers the toner image of the corresponding color formed on the surface of the photosensitive drum 22 to the sheet P by charging the sheet P to an opposite polarity with respect to the toner.

Further, inside the apparatus casing 2, a sheet tray 27 that accommodates the sheet P is provided below the transfer unit 24 (that is, at a lower part in the apparatus casing 2). Further, inside the apparatus casing 2, a carrying roller pair and the like for carrying the sheet P are provided on the carrying path R between the sheet tray 27 and the transfer unit 24.

Further, inside the apparatus casing 2, the fuser unit 10 is provided on a sheet carrying direction downstream side (that is, a rear side) of the transfer unit 24. A fuser 8 of the fuser unit 10 includes a heating roller 28 and a backup roller 29 which is arranged opposing a lower side of the heating roller 28 with the carrying path R sandwiched therebetween. The toner image transferred to the sheet P by the transfer unit 24 is fused onto the sheet P by being heated and pressed by the heating roller 28 and the backup roller 29. Further, inside the apparatus casing 2, an ejection roller pair and the like for ejecting the sheet P from the sheet ejection port 6 to the sheet stacker part 5 are provided on the carrying path R between the fuser unit 10 and the sheet ejection port 6.

### 3. Configurations of the Top Cover, the Fuser Unit, and their Peripheral Parts

Next, configurations of the top cover 2c, the fuser unit 10, and their peripheral parts are described in more detail. Here, of the configurations of the top cover 2c, the fuser unit 10 and their peripheral parts, only configurations of portions related to opening and closing of the top cover 2c and attachment and detachment of the fuser unit 10 are described.

### 4. Configuration of the Top Cover

As illustrated in FIGS. 4, 9 and 10, the top cover rotation shaft 4 provided at the rear end of the top cover 2c is rotatably supported by the bearing part (not illustrated in the drawings) provided at the upper end of the rear end part of the casing main body part 2m. Specifically, the top cover rotation shaft 4 is positioned on a rear side of the top cover insertion port rear side wall surface 5b of the sheet stacker part 5. The top cover 2c opens and closes by rotating around the top cover rotation shaft 4.

Further, the sheet stacker part 5 is provided on the upper surface of the top cover 2c, and the fuser insertion port 7 is provided at the rear part of the sheet stacker part 5. The fuser insertion port 7 is about the same in size as the upper surface of the fuser unit 10, and is a hole that opens the rear part of the sheet stacker part 5 and left and right two outer side portions thereof. Of the entire top cover 2c, a portion forming a front part of the stack surface 5s of the sheet stacker part 5 is referred to as a top cover stack surface formation part 40s as a cover stack surface, and portions respectively forming front parts of the left and right stack part side wall surfaces 5w of the sheet stacker part 5 are referred to as top cover side wall surface formation parts 40w. That is, the fuser insertion port 7 is provided between the top cover insertion port rear side wall surface 5b of the sheet stacker part 5 and those top cover stack surface formation part 40s and top cover side wall surface formation parts 40w.

Two top cover front side seats 60 (FIG. 5) are respectively formed on slightly inner sides of left and right two ends of the rear end part of the top cover stack surface formation part 40s at a predetermined interval in the left-right direction. The top cover front side seats 60 each have a planar shape that is recessed downward relative to the top cover stack surface formation part 40s, and each have a slightly larger rectangular shape in a plan view than each of sub cover front side arms 62 (to be described later).

Further, two top cover rear side seats 61 (FIG. 5) are respectively formed at left and right two end parts of an upper end part of the top cover insertion port rear side wall surface 5b at a larger interval in the left-right direction than the top cover front side seats 60. The top cover rear side seats 61 are each a plate-like member protruding forward from the top cover insertion port rear side wall surface 5b, and each have a flat upper surface.

In the casing main body part 2m, a fuser accommodating part 42 for detachably accommodating the fuser unit 10 is provided below the fuser insertion port 7 of the top cover 2c in the top cover closed state.

### 5. Configuration of the Fuser Unit

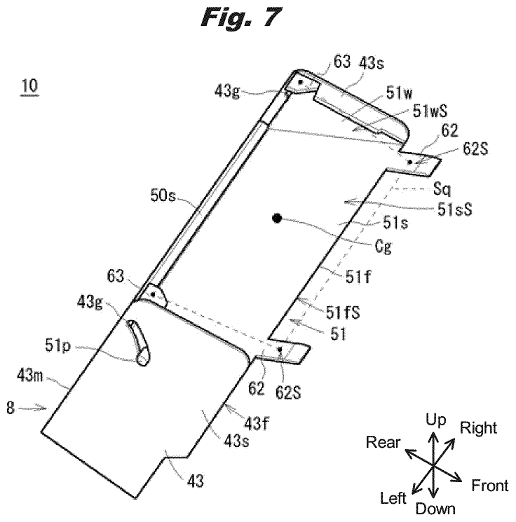

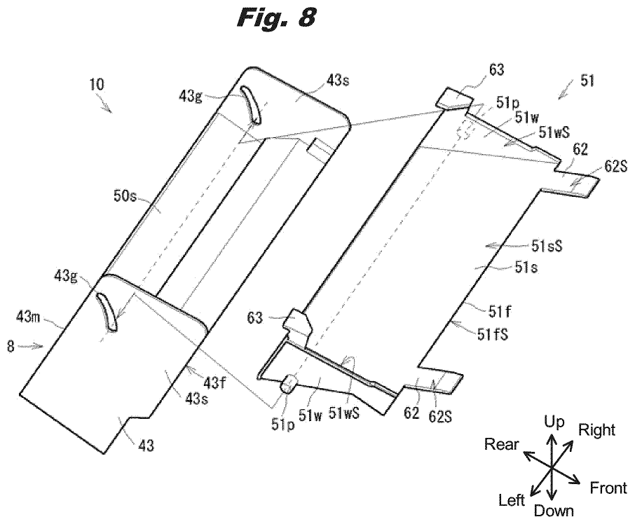

As illustrated in FIGS. 7, 8, 11 and 12, the fuser unit 10 includes the fuser 8 and the sub cover 51.

### 6. Configuration of the Fuser

The fuser 8 has as an external covering a substantially rectangular parallelepiped fuser casing 43 which is long in the left-right direction. The fuser casing 43 is accommodated in the fuser accommodating part 42 of the casing main body part 2m in a state in which an upper surface thereof is exposed from the fuser insertion port 7 to the outside. The fuser accommodating part 42 accommodates the fuser casing 43 in a state in which the fuser casing 43 is inclined forward, and the fuser casing 43 can be taken out by pulling the fuser casing 43 obliquely forward and upward (in the fuser removal direction). Further, the sub cover 51 is attached to an upper surface side as an exposed portion of the fuser casing 43, and the sub cover 51 forms the rear part of the sheet stacker part 5 (that is, the rear parts of the stack surface 5s and the left and right stack part side wall surfaces 5w).

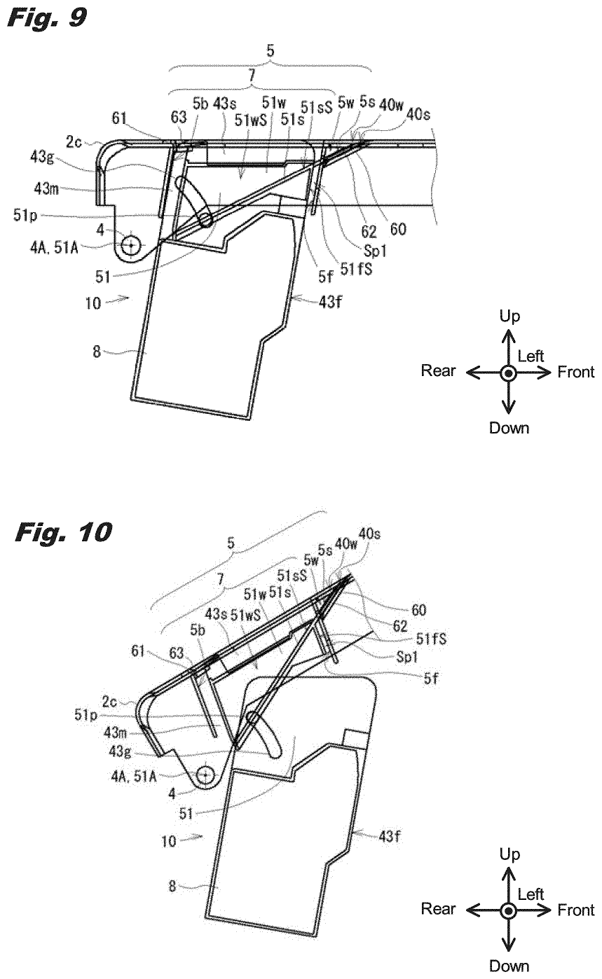

The fuser casing 43 is covered with a fuser cover 43m. The fuser cover 43m has fuser cover side plates 43s. The fuser cover side plates 43s respectively form left and right two end parts of the fuser cover 43m, each have the same width as the fuser unit 10 in the front-rear direction, and each have a plate shape that extends long in the vertical direction (or the up-down direction). Further, a fuser covers front side wall surface 43f (FIG. 4) is formed at a front end part of the fuser cover 43m. The fuser cover front side wall surface 43f has a planar shape, and, in the fuser attached state (FIG. 9), is arranged on the same plane as a sub cover front side wall surface 51fS of the sub cover 51. Here, of the entire fuser cover 43m, an upper surface positioned on a lower side of a sub cover stack surface formation part 51s of the sub cover 51 is referred to as a fuser cover upper surface 50s. Further, on the fuser cover 43m, handles (not illustrated in the drawings) are respectively provided on left and right two outer side portions of the sheet stacker part 5.

Sub cover guide grooves 43g, which are each an arc-shaped long hole, are respectively drilled in upper side rear parts of the fuser cover side plates 43s. The sub cover guide grooves 43g as regulation parts each have an arc shape of which a radius is a cover guide groove radius R1 and which is centered on a sub cover rotation center axis 51A which is positioned on the same axis as the top cover rotation center axis 4A of the top cover 2c. The sub cover guide grooves 43g are each formed over a rotation angle range of about 30 degrees. The sub cover guide grooves 43g each have a groove width that is slightly larger than an outer diameter of each of sub cover posts 51p (to be described later) of the sub cover 51, and respectively allow the sub cover posts 51p to slide therein in a state in which the sub cover posts 51p are respectively inserted into the sub cover guide grooves 43g. Therefore, while the sub cover posts 51p are respectively slid in the sub cover guide grooves 43g of the fuser cover 43m, the sub cover 51 is rotated about the sub cover rotation center axis 51A which is a common rotation axis as the top cover rotation center axis 4A.

Further, in the image forming apparatus 1, in opening and closing the top cover 2c, in order to prevent interference between the top cover insertion port front side wall surface 5f of the top cover 2c and the fuser casing 43, a gap Sp1 (FIG. 9) is provided between the top cover insertion port front side wall surface 5f of the top cover 2c and the fuser casing 43 of the fuser unit 10 accommodated in the fuser accommodating part 42 in the top cover closed state.

However, when the gap Sp1 between the top cover insertion port front side wall surface 5f of the top cover 2c and the fuser cover front side wall surface 43f of the fuser cover 43m is open, there is a possibility that a sheet P ejected to the sheet stacker part 5 enters into the inside of the apparatus casing 2 from the gap Sp1, or a foreign body enters into the inside of the apparatus casing 2 from the gap Sp1. Therefore, in addition to the fuser cover 43m, the sub cover 51 that covers the gap Sp1 is attached to the upper surface of the fuser casing 43.

### 7. Configuration of the Sub Cover

The sub cover 51 is attached to the fuser cover 43m so as to cover an upper part of the fuser cover 43m. That is, the upper surface of the fuser casing 43 has a double-layered structure including the fuser cover 43m and the sub cover 51, and the sub cover 51 forms the rear part of the sheet stacker part 5. Here, of the entire sub cover 51, a portion forming a rear part of the stack surface 5s of sheet stacker part 5 is referred to as a sub cover stack surface formation part 51s, and portions respectively forming the stack part side wall surfaces 5w are referred to as sub cover side wall surface formation parts 51w. The sub cover stack surface formation part 51s and the sub cover side wall surface formation parts 51w of the sub cover 51 form surfaces on extension lines of the top cover stack surface formation part 40s and the top cover side wall surface formation parts 40w of the top cover 2c, and the sheet stacker part 5 is formed by the sub cover stack surface formation part 51s and the sub cover side wall surface formation parts 51w of the sub cover 51 and the top cover stack surface formation part 40s and the top cover side wall surface formation parts 40w of the top cover 2c.

The sub cover stack surface formation part 51s is a flat plate member that inclines forward and upward with respect to a horizontal direction, and, on an upper surface thereof, a sub cover stack surface 51sS as a planar sub cover stack surface that occupies most of a rear side of the stack surface 5s of the sheet stacker part 5 is formed. The sub cover stack surface formation part 51s slightly overlaps an upper side of the rear end part of the top cover stack surface formation part 40s of the top cover 2c.

A sub cover front side wall 51f is a flat plate member that extends downward from front end parts of the sub cover side wall surface formation parts 51w and is arranged in parallel to the fuser cover front side wall surface 43f of the fuser cover 43m, and on a front surface thereof, the sub cover front side wall surface 51fS is formed. The sub cover front side wall surface 51fS has a planar shape, and, in the fuser attached state, faces the top cover insertion port front side wall surface 5f (FIG. 9) of the top cover 2c in the front-rear direction. Further, in the fuser attached state, a slight gap Sp1 is formed between the top cover insertion port front side wall surface 5f of the top cover 2c and the sub cover front side wall surface 51fS of the sub cover 51. Further, in the fuser attached state, the sub cover front side wall surface 51fS is arranged on the same plane parallel to the fuser cover front side wall surface 43f of the fuser cover 43m.

The sub cover side wall surface formation parts 51w are flat plate members that respectively extend upward from left and right two end parts of the sub cover stack surface formation part 51s and arranged in parallel to the left and right side plates of the fuser cover 43m, and, on left and right inner surfaces thereof, sub cover side wall surfaces 51wS are respectively formed. The sub cover side wall surfaces 51wS each have a planar shape, and respectively form left and right two outer side surfaces of a rear portion of the sheet stacker part 5.

From slightly inner sides of left and right two ends of a front end part of the sub cover stack surface formation part 51s, at an interval equal to that of the top cover front side seats 60 (FIG. 5) in the left-right direction, the sub cover front side arms 62 as two second engaging parts protrude forward in the sheet carrying direction to a front side of the fuser cover 43m. The sub cover front side arms 62 each have a rectangular plate shape similar to the top cover front side seats 60 (FIG. 5), and an up-down direction thickness of the sub cover front side arms 62 from a front end part to a rear end part is the same as an up-down direction depth of the top cover front side seats 60. In the fuser attached state (FIGS. 1, 3, 6 and 9), by fitting the sub cover front side arms 62 in the recesses of the top cover front side seats 60 in a manner that the lower surfaces of the sub cover front side arms 62 are in contact with the upper surfaces of the top cover front side seats 60 positioned on a front side of the sub cover stack surface formation part 51s, that is, in a manner that the sub cover front side arms 62 are placed on the top cover front side seats 60, the sub cover front side arm upper surfaces 62S, which are upper surfaces of the sub cover front side arms 62, and the top cover stack surface formation part 40s overlap and are smoothly connected.

The sub cover 51 covers the gap Sp1 from above by arranging the sub cover front side arms 62 at a carrying width direction interval larger than a carrying width direction length of the sheet and by overlapping the rear end part of the top cover stack surface formation part 40s of the top cover 2c with the sub cover front side arms 62. Therefore, the stack surface 5s of the sheet stacker part 5 is formed by the top cover stack surface formation part 40s of the top cover 2c, the sub cover stack surface formation part Ms of the sub cover 51, and the sub cover front side arm upper surfaces 62S of the sub cover front side arms 62 of the sub cover 51 so that there is no gap. By doing so, in the image forming apparatus 1, in the state in which the upper surface of the fuser unit 10 is exposed from the fuser insertion port 7 of the top cover 2c, the top cover 2c can be smoothly opened or closed, and a foreign body such as a sheet can be prevented from entering between the left and right sub cover front side arms 62 and further entering into the apparatus casing 2 from the gap Sp1.

Further, the sub cover stack surface formation part Ms of the sub cover 51 slightly overlaps the upper side of the rear end part of the top cover stack surface formation part 40s of the top cover 2c, and covers the gap Sp1 from above. Therefore, the sub cover 51 blocks the gap Sp1 so that cooling air Ar (to be described later) does not leak to the outside via the gap Sp1, and maintains cooling efficiency.

Further, from upper end parts of rear end parts of the sub cover side wall surface formation parts 51w, that is, from left and right two sides above the sheet ejection port 6, two sub cover rear side arms 63 as first engaging parts respectively protrude to inner sides in the left-right direction which is the carrying width direction at an interval equal to that of the top cover rear side seats 61 (FIG. 5) in the left-right direction. The sub cover rear side arms 63 each have a substantially trapezoidal plate shape in a plan view. In the fuser attached state (FIGS. 1, 3, 6 and 9), the sub cover rear side arms 63 are respectively placed on the top cover rear side seats 61 in a manner that lower surfaces of the sub cover rear side arms 63 are respectively in contact with the top cover rear side seats 61 (FIG. 5). In this case, the sub cover 51 can be stably placed on the top cover 2c by positioning a sub cover gravity center Cg (FIG. 7), which is the gravity center of the sub cover 51, on an inner side of a quadrangle Sq formed by connecting contact points between the top cover rear side seats 61 and the sub cover rear side arms 63 and contact points between the top cover front side seats 60 and the sub cover front side arms 62.

In the fuser attached state, the sub cover rear side arms 63 are provided at a predetermined distance from the top cover rotation center axis 4A, and the sub cover front side arms 62 are provided at a longer distance than the sub cover rear side arms 63 from the top cover rotation center axis 4A.

Further, the cylindrical sub cover posts 51p respectively protrude to outer sides in the left-right direction from rear sides near lower end parts of the sub cover side wall surface formation parts 51w. The sub cover posts 51p as third engaging parts are slidably fitted into the sub cover guide grooves 43g of the fuser cover side plates 43s. Therefore, the sub cover 51 rotates about the sub cover rotation center axis 51A, that is, about the top cover rotation center axis 4A with respect to the fuser cover 43m while the sub cover posts 51p slide in the sub cover guide grooves 43g.

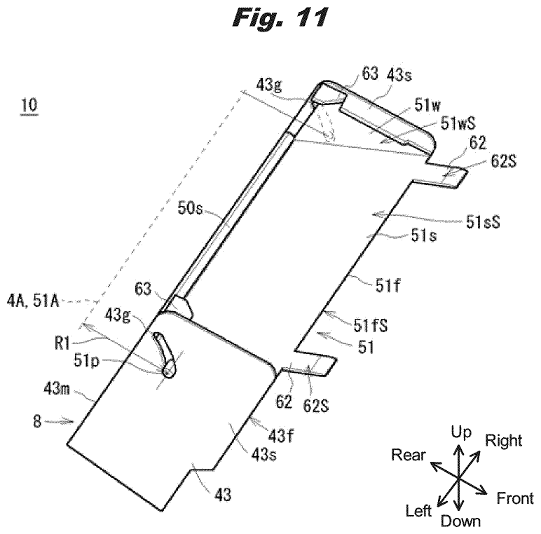

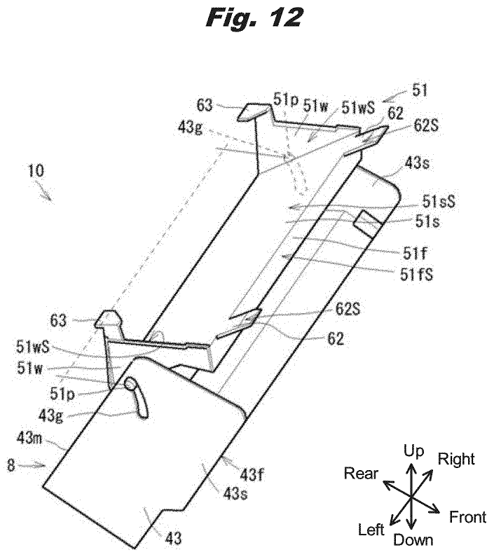

As a result, as illustrated in FIGS. 11 and 12, the sub cover 51 opens when the sub cover stack surface formation part 51s of the sub cover 51 rotates about the sub cover rotation center axis 51A in a sub cover opening direction which is a counterclockwise direction in FIG. 12 which is a direction away from the fuser cover upper surface 50s of the fuser cover 43m, and, on the other hand, the sub cover 51 closes when the sub cover stack surface formation part 51s of the sub cover 51 rotates in a sub cover closing direction which is a clockwise direction in FIG. 11 which is a direction approaching the fuser cover upper surface 50s of the fuser cover 43m.

Further, by fitting the sub cover posts 51p of the sub cover 51 into the sub cover guide grooves 43g of the fuser cover side plates 43s, even in the fuser detached state, the sub cover 51 is prevented from being detached from the fuser 8, handling of the fuser unit 10 is facilitated, and the position of the sub cover 51 with respect to the fuser cover 43m is regulated.

Here, as a state of the sub cover 51, a state in which, in the top cover closed state (FIGS. 1 and 9), the sub cover posts 51p are respectively positioned at lower end parts of the sub cover guide grooves 43g, and the sub cover stack surface formation part Ms is near the fuser cover upper surface 50s of the fuser cover 43m is also referred to as a sub cover closed state illustrated in FIG. 11. Further, as a state of the sub cover 51, a state in which, in the top cover opened state (FIGS. 2 and 10), the sub cover posts 51p are respectively positioned at upper end parts of the sub cover guide grooves 43g, and the sub cover stack surface formation part 51s is apart from the fuser cover upper surface 50s of the fuser cover 43m is also referred to as a sub cover opened state illustrated in FIG. 12.

Further, the sub cover 51 is biased by a torsion spring (not illustrated in the drawings) in the sub cover closing direction in which the sub cover stack surface formation part 51s of the sub cover 51 approaches the fuser cover upper surface 50s of the fuser cover 43m.

In such a configuration, since the sub cover front side arms 62 are in contact with the top cover front side seats 60 and the sub cover rear side arms 63 are in contact with the top cover rear side seats 61, when the top cover 2c opens, the sub cover front side arms 62 are lifted upward by the top cover front side seats 60 of the top cover 2c, and the sub cover rear side arms 63 are lifted upward by the top cover rear side seats 61, and thus, the sub cover 51 integrally opens together with the top cover 2c. Further, when the top cover 2c closes, the sub cover 51 closes together with the top cover 2c due to the biasing force of the torsion spring (not illustrated in the drawings). In this way, the sub cover 51 covers the gap Sp1 and integrally opens or closes with the top cover 2c as the top cover 2c opens or closes.

In the sub cover opened state, the sub cover closed state, and all the states of the sub cover 51 during the transition between sub cover opened state and the sub cover closed state, the sub cover front side arms 62 are always in contact with the top cover front side seats 60, and the sub cover rear side arms 63 are always in contact with the top cover rear side seats 61.

### 8. Take-Out Operation of the Fuser

Next, a take-out operation in which the fuser unit 10 is taken out is described. The take-out operation of the fuser unit 10 is an operation in which the fuser unit 10 is taken out from the image forming apparatus 1 at the time of replacement of the fuser unit 10 due to expiration of its life or when sheet jamming has occurred in the fuser unit 10. While the top cover 2c of the image forming apparatus 1 is closed, a user takes out the fuser unit 10 attached to the casing main body part 2m from the inside of the casing main body part 2m via the fuser insertion port 7 of the top cover 2c by grasping the handles (not illustrated in the drawings) exposed from the fuser insertion port 7 of the top cover 2c to pull the fuser unit 10 obliquely forward and upward (in the fuser removal direction).

On the other hand, an attaching operation in which the fuser unit 10 is attached to the casing main body part 2m is a reverse operation of the take-out operation. That is, the user attaches the fuser unit 10 to the casing main body part 2m by pushing the fuser unit 10 down from the fuser insertion port 7 of the top cover 2c in the fuser insertion direction D2 into the casing main body part 2m.

### 9. Opening Operation of the Top Cover

Next, an opening operation of the top cover 2c is described. The opening operation of the top cover 2c is an operation in which the top cover 2c is opened when the carrying belt 25 is replaced or when sheet jamming has occurred on an upstream side of the fuser unit 10 in the sheet carrying direction.

First, in the top cover closed state, as illustrated in FIGS. 1, 9 and 11, the sub cover front side arms 62 of the sub cover 51 are in contact, from above, with the top cover front side seats 60 of the top cover 2c, and the sub cover rear side arms 63 of the sub cover 51 are in contact, from above, with the top cover rear side seats 61 of the top cover 2c. Further, the top cover rotation center axis 4A of the top cover 2c and the sub cover rotation center axis 51A of the sub cover 51 are on the same axis.

As illustrated in FIGS. 2, 10 and 12, a user grasps the handle (not illustrated in the drawings) provided on the top cover 2c and lifts a front part of the top cover 2c upward, and, thereby, the top cover 2c rotates about the top cover rotation center axis 4A in the top cover opening direction and opens, and the top cover opened state is achieved. In this case, the sub cover front side arms 62 and the sub cover rear side arms 63 are respectively lifted upward in the top cover opening direction by the top cover 2c from the top cover front side seats 60 of the top cover 2c and from the top cover rear side seats 61 of the top cover 2c, and thereby, the sub cover 51 of the fuser unit 10 opens together with the top cover 2c. Further, in this case, with its movement direction regulated by the sliding of the sub cover posts 51p in the sub cover guide grooves 43g of the fuser cover 43m, the sub cover 51 of the fuser unit 10 rotates about the sub cover rotation center axis 51A, that is, the top cover rotation center axis 4A, in the sub cover opening direction on a rotation orbit of the same curvature as the top cover 2c. As a result, the sub cover 51 integrally rotates with the top cover 2c in the sub cover opening direction while a relative positional relationship in which the sub cover 51 is in contact with the top cover 2c is maintained between the sub cover 51 and the top cover 2c.

On the other hand, a closing operation in which the top cover 2c is closed is a reverse operation of the opening operation. That is, the user closes the top cover 2c by pushing the front part of the opened top cover 2c downward to rotate the top cover 2c in the top cover closing direction. In this case, the sub cover 51 of the fuser unit 10 is lifted by the top cover 2c and integrally rotates with the top cover 2c in the sub cover closing direction, and closes together with the top cover 2c by the biasing force of the torsion spring.

Also in this case, with its movement direction regulated by the sliding of the sub cover posts 51p in the sub cover guide grooves 43g of the fuser cover 43m, the sub cover 51 of the fuser unit 10 rotates about the sub cover rotation center axis 51A, that is, the top cover rotation center axis 4A, in the top cover closing direction on a rotation orbit of the same curvature as the top cover 2c. As a result, the sub cover 51 integrally rotates with the top cover 2c in the top cover closing direction while a relative positional relationship in which the sub cover 51 is in contact with the top cover 2c is maintained between the sub cover 51 and the top cover 2c.

### 10. Effects and the Like

In the image forming apparatus 1 having the above configuration, the fuser insertion port 7 is provided at the rear part of the sheet stacker part 5 provided on the upper surface of the top cover 2c, and the fuser unit 10 detachably accommodated in the casing main body part 2m can be taken out via the fuser insertion port 7. Therefore, in the image forming apparatus 1, with the top cover 2c closed, the fuser unit 10 can be directly taken out from the fuser insertion port 7. As a result, in the image forming apparatus 1, workability in taking out the fuser unit 10 can be improved as compared to a conventional technology can be improved.

Further, in the image forming apparatus 1, in the top cover closed state, the sub cover 51 which is the upper surface of the fuser unit 10 exposed from the fuser insertion port 7 forms the rear part of the sheet stacker part 5. Therefore, in the image forming apparatus 1, for example, the apparatus casing 2 can be downsized as compared to a case where the sheet stacker part 5 and the fuser insertion port 7 are separately provided on the top cover 2c.

Here, it is also possible that the top cover 2c and the sub cover 51 rotate about different rotation axes. However, in that case, although the top cover 2c and the sub cover 51 are interlocked, the relative positional relationship with each other changes as the top cover 2c and the sub cover 51 rotate. Therefore, in a state in which sheets are placed on the stack surface 5s, when the top cover 2c rotates in the top cover opening direction, at a joint between the top cover stack surface formation part 40s and the sub cover stack surface 51sS in the stack surface 5s, a height difference may occur, or a large angular change may occur, and there is a possibility that a sheet may deform in shape or a sheet may fall off from the stack surface 5s. Further, in such a case, since the top cover 2c and the sub cover 51 separately rotate on mutually different rotation orbits, in order to avoid physical interference between the top cover 2c and the sub cover 51 when the top cover 2c and the sub cover 51 rotate, it is necessary to design a larger gap Sp1 between the top cover 2c and the sub cover 51.

In contrast, in the image forming apparatus 1, the top cover 2c is rotated in a state in which the sub cover front side arms 62 of the sub cover 51 are in contact with the upper sides of the top cover front side seats 60, the sub cover rear side arms 63 are in contact with the upper sides of the top cover rear side seats 61, and sub cover 51 is placed on the top cover 2c. Therefore, in the image forming apparatus 1, the sub cover 51 can be integrally rotated with the top cover 2c while maintaining the relative positional relationship with the top cover 2c.

Further, in the image forming apparatus 1, the sub cover posts 51p are slid along the sub cover guide grooves 43g centered on the sub cover rotation center axis MA which is on the same axis as the top cover rotation center axis 4A of the top cover 2c, and the sub cover 51 is rotated about the same axis as the top cover 2c Therefore, in the image forming apparatus 1, the sub cover 51 can be stably rotated on a rotation orbit having the same curvature as the top cover 2c.

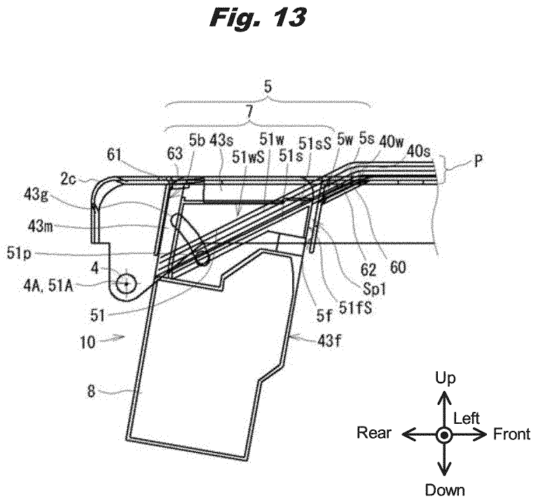

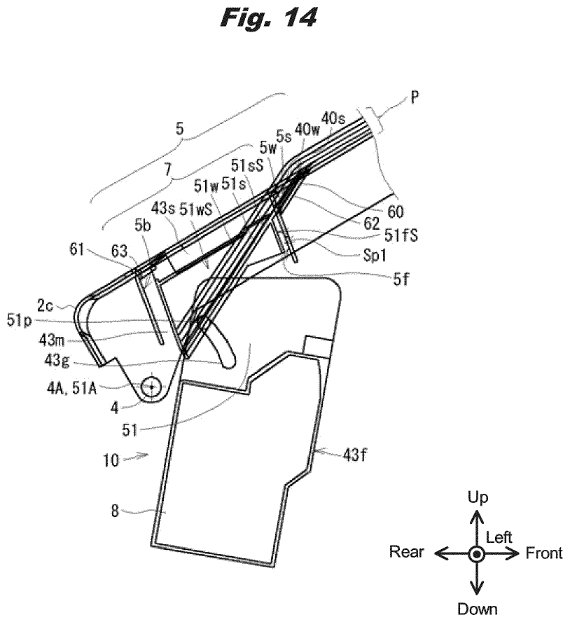

Therefore, in the image forming apparatus 1, in opening or closing the top cover 2c, at the joint between top cover stack surface formation part 40s and the sub cover stack surface 51sS in the stack surface 5s, the top cover stack surface formation part 40s and the sub cover stack surface 51sS can always be smoothly connected without causing a height difference or a large angular change. As a result, in the image forming apparatus 1, as illustrated in FIGS. 13 and 14, even in the state in which sheets are stacked on the stack surface 5s, the top cover 2c can be opened or closed while the sheets are stably kept on the stack surface 5s without sheet breaking.

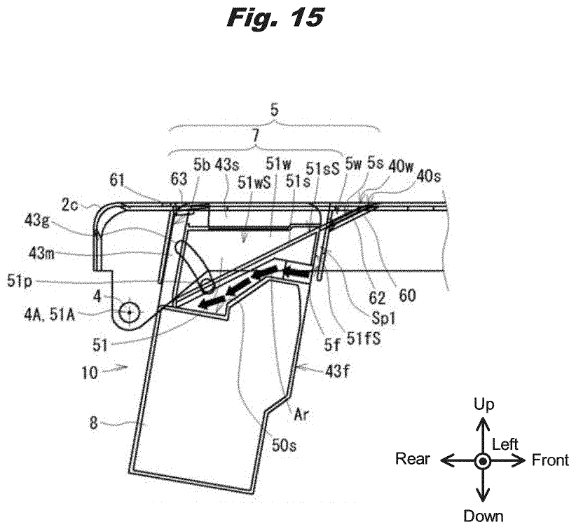

Further, in the image forming apparatus 1, since the top cover 2c and the sub cover 51 are integrally rotated, as compared to a case where the top cover 2c and the sub cover 51 are separately rotated on different rotation orbits, a small gap Sp1 between the top cover 2c and the sub cover 51 can be designed. Therefore, in the image forming apparatus 1, as illustrated in FIG. 15, inside the apparatus casing 2, cooling air Ar supplied from front toward the fuser unit 10 does not leak to the outside from the gap between the top cover 2c and the sub cover 51, and can pass between the fuser cover 43m and the sub cover 51 which also serves as the sheet stacker part 5.

Therefore, in the image forming apparatus 1, the sub cover stack surface formation part 51s of the sub cover 51, which also serves as the sheet stacker part 5, can be efficiently air-cooled, and cooling efficiency can be improved. As a result, in the image forming apparatus 1, the temperature of the sheet stacker part 5, which is arranged near the upper side of the fuser unit 10 where the temperature is high, can be prevented from becoming high, a sheet after printing can be prevented from becoming curled, and toner on a surface of a sheet can be prevented from re-melting and sticking to the stack surface 5s.

According to the above configuration, the image forming apparatus 1 includes: the apparatus casing 2; the top cover 2c that has the fuser insertion port 7 as an opening part and is provided rotatable in a rotation direction about the top cover rotation center axis 4A as a rotation axis with respect to the apparatus casing 2; the fuser 8 that is provided attachable to and detachable from the apparatus casing 2 via the fuser insertion port 7 and fuses a toner image formed on the sheet P as a medium; and the sub cover 51 that is provided on the fuser 8 and forms a part of an exterior surface of the top cover 2c. The sub cover 51 moves in the rotation direction due to the rotation of the top cover 2c.

As a result, in the image forming apparatus 1, the fuser 8 can be directly taken out from the apparatus casing 2 via the fuser insertion port 7 of the top cover 2c which rotates the sub cover 51.

### 11. Other Embodiments

In the above-described embodiment, the case is described where two sub cover front side arms 62 protrude from the front end part of the sub cover stack surface formation part 51s. The present invention is not limited to this. Any number of sub cover front side arms 62 may be provided such as that a total of three sub cover front side arms 62 are provided by further providing one sub cover front side arm 62 protruding from a carrying width direction center part at the front end part of the sub cover stack surface formation part 51s, or that only one sub cover front side arm 62 protruding from the carrying width direction center part is provided. Further, a sub cover front side arm 62 having a wide width extending from one end side to the other end side in the carrying width direction at the front end part of the sub cover stack surface formation part 51s may be formed. Further, it is also possible that the sub cover front side arms 62 are omitted, and the front end part of the sub cover stack surface formation part 51s overlaps with the rear end part of the top cover stack surface formation part 40s.

Further, in the above-described embodiment, the case is described where the sub cover guide grooves 43g are respectively formed at the upper side rear parts of the fuser cover side plates 43s. The present invention is not limited to this. The sub cover guide grooves 43g may be formed at various other places as long as the sub cover guide grooves 43g each have an arc shape that has the same curvature as the rotation path of the top cover 2c about the sub cover rotation center axis 51A.

Further, in the above-described embodiment, the case is described where the sub cover posts 51p are provided on the sub cover 51, and the sub cover guide grooves 43g are provided on the fuser cover 43m. The present invention is not limited to this. It is also possible that the arrangement of the posts and the grooves is reversed, and the sub cover posts are provided on the fuser cover 43m, and the sub cover guide grooves are provided on the sub cover 51.

Further, in the above-described embodiment, the case is described where the sub cover posts 51p of the sub cover 51 are respectively fitted in the sub cover guide grooves 43g of the fuser cover 43m. The present invention is not limited to this. As long as the sub cover 51 can be prevented from coming off the fuser cover 43m and the movement of the sub cover 51 with respect to the fuser cover 43m can be regulated, the sub cover guide grooves 43g and the sub cover posts 51p may have other configurations, or the sub cover guide grooves 43g and the sub cover posts 51p may be omitted.

Further, when the present invention is applied to an image forming apparatus in which the upper surface of the fuser unit 10 has a position and a size different from those in the above-described embodiment, the position and size of the fuser insertion port 7 may be appropriately modified.

Further, in the above-described embodiment, the case is described where the present invention is applied to the image forming apparatus 1 which is an electrophotographic printer. Without being limited to this, the present invention may also be applied to an image forming apparatus having a configuration different from the image forming apparatus 1 as long as the image forming apparatus is an electrophotographic image forming apparatus. For example, the present invention may also be applied to an image forming apparatus having a configuration in which a toner image formed by an image forming unit is transferred an intermediate transfer belt, and then, to a medium. Further, the present invention may also be applied to a monochromatic image forming apparatus having one image forming unit, or a color image forming apparatus having five or more image forming units. Further, the present invention may also be applied to an image forming apparatus in which an image is formed on a medium other than a sheet of paper. Further, the present invention may also be applied to image forming apparatuses such as an electrophotographic copying machine, a facsimile machine, and a multifunction machine.

Further, in the above-described embodiments, the image forming units 20 as specific examples of image forming parts that form an image on a medium are provided in the image forming apparatus 1. However, without being limited to this, image forming parts having configurations different from the image forming units 20 may be provided in the image forming apparatus 1.

Further, the present invention is not limited to the above-described embodiments and other embodiments. That is, the application scope of the present invention also covers embodiments obtained by arbitrarily combining some or all of the above-described embodiments and the above-described other embodiments, and embodiments obtained by extracting some of the above-described embodiments and other embodiments.

Further, in the above-described embodiment, the case is described where the image forming apparatus 1 as an image forming apparatus is configured by the apparatus casing 2 as an apparatus main body, the top cover 2c as a cover member, the fuser 8 as a fuser, and the sub cover 51 as a sub cover member. The present invention is not limited to this. An image forming apparatus may be configured by an apparatus main body, a cover member, a fuser, and sub cover member, which have various other configurations.

In this application, an upper surface of the image forming apparatus means one surface on which image formed media are stacked or collected, which are ejected after image forming process is completed. When the image forming apparatus stands up right, the upper surface may face a side way which is parallel to the ground.

The present invention can be widely used in image forming apparatuses such as an electrophotographic printer, a copying machine, a facsimile, and a multifunction machine.

What is claimed is:

1. An image forming apparatus comprising:
an apparatus main body;
a cover member that is provided rotatable in a rotation direction about a rotation axis with respect to the apparatus main body, having an opening part,
a fuser that fuses a toner image formed on each medium of media wherein the fuser is attached to the apparatus main body by being inserted through the opening part and detached from the apparatus main body by being pulled out of the opening part; and
a sub cover member that has an surface portion and is attached to the fuser, wherein
in a state in which the fuser is attached to the image forming apparatus, the surface portion of the sub cover is arranged within the opening part,
the sub cover member moves in the rotation direction in correspondence with the rotation of the cover member.

2. The image forming apparatus according to claim 1, wherein
the rotation axis of the cover member is arranged parallel to a width direction of the media that are carried through the image forming apparatus such that the cover member rotates back and forth around the rotation axis,
the sub cover member has a center axis around which the sub cover member rotates back and forth, and
the center axis of the sub cover member is coaxial to the rotation axis of the cover member such the sub cover member rotates together with the rotation of the cover member around the rotation axis.

3. The image forming apparatus according to claim 2, wherein
the cover member and the sub cover member are placed on an upper surface of the apparatus main body,
each of the media on which the toner image has been fixed by the fuser comes out through the opening part, reaching the continuous surface such that the media are stacked on the continuous surface in a vertical direction.

4. The image forming apparatus according to claim 1, wherein
the sub cover member has
a first engaging part that is provided at a position at a predetermined distance from the rotation axis and engages with the cover member, and
a second engaging part that is provided at a farther distance than the first engaging part from the rotation axis with respect to a view of the rotation axis, and engages with the cover member, and
the sub cover member moves in a state in which the first engaging part and the second engaging part are engaged with the cover member.

5. The image forming apparatus according to claim 4, wherein
when the cover member opens by rotating in the rotation direction, the second engaging part is pushed up by the cover member, and thereby, the sub cover member is rotated by the cover member.

6. The image forming apparatus according to claim 1, wherein
the sub cover member has a third engaging part that engages with the fuser,
the fuser has a guide part that engages with the third engaging part and guides the sub cover member to move in the rotation direction, and
the sub cover member can be moved in the rotation direction by the cover member while the third engaging part is guided by the guide part provided on the fuser.

7. The image forming apparatus according to claim 6, wherein
the guide part is a long hole formed in an arc shape, and
the third engaging part is a protruding part inserted into the long hole.

8. The image forming apparatus according to claim 1, wherein
the sub cover member has a sub cover stack surface that forms a portion of the exterior surface of the cover member and is for stacking the media.

9. The image forming apparatus according to claim 8, wherein
the sub cover member has the sub cover stack surface on an exposed portion, which is exposed from the opening part when the fuser is attached to the apparatus main body,
the cover member has a cover stack surface for stacking the media on an outer peripheral part, and
when the fuser is attached to the apparatus main body, a stack surface on which the media are stacked is formed by connecting the sub cover stack surface and the cover stack surface.

10. The image forming apparatus according to claim 9, wherein
the sub cover member covers a gap (Sp1) provided between the sub cover stack surface and the cover stack surface.

11. The image forming apparatus according to claim 10, wherein
the rotation axis around which the cover member and the sub cover member open or close by rotating is positioned on an opposite side with respect to the gap at the exposed portion of the sub cover member.

12. The image forming apparatus according to claim 1, wherein
the sub cover member engages with the cover member such that a gravity center thereof is within a range surrounding multiple places at which the sub cover member engages with the cover member.
